(19) United States
(12) Patent Application Publication
(10) Pub. No.: US 2015/0037594 A1
(43) Pub. Date: Feb. 5, 2015

(54) GLASS COMPOSITION, SEALING MATERIAL, AND SEALED PACKAGE

(71) Applicant: ASAHI GLASS COMPANY, LIMITED, Chiyoda-ku (JP)

(72) Inventor: Sohei KAWANAMI, Chiyoda-ku (JP)

(73) Assignee: ASAHI GLASS COMPANY, LIMITED, Chiyoda-ku (JP)

(21) Appl. No.: 14/340,821

(22) Filed: Jul. 25, 2014

(30) Foreign Application Priority Data
Jul. 30, 2013 (JP) 2013-157839

(51) Int. Cl. C03C 8/24; C03C 8/04; B32B 17/00; C03C 8/02

(52) U.S. Cl. CPC C03C 8/24; C03C 8/02; C03C 8/04; B32B 17/00; C03C 2205/00; B32B 2457/00
USPC 428/427; 501/14; 501/15; 428/426; 428/697; 428/428

(57) ABSTRACT

It is an object to provide a glass composition in which foaming due to a reaction with a nitride film is suppressed. A glass composition contains, in mole percentage based on following oxides, 30% to 90% of TeO₂, 0% to 60% of ZnO, 0% to 24% of B₂O₃, 0% to 8% of Li₂O+Na₂O+K₂O, 0% to 8% of Al₂O₃, 0% to 17% of Bi₂O₃, 0% to 30% of V₂O₅, and 0% to 10% of SiO₂; and does not substantially contain any of components which includes F, Pb, Cd, W, Mo, Ag, or Gd.

### CROSS-REFERENCE TO RELATED APPLICATION

This application is based upon and claims the benefit of priority from Japanese Patent Application No. 2013-157839, filed on Jul. 30, 2013; the entire contents of which are incorporated herein by reference.

### FIELD

The present invention relates to a glass composition, a sealing material, and a sealed package.

### BACKGROUND

Flat panel display devices (FPD) such as an organic electro-luminescence display (OELD) and a plasma display panel (PDP) have a structure in which a light emitting element is sealed in a glass package in which a pair of glass substrates is sealed. Further, a liquid crystal display device (LCD) also has a structure in which a liquid crystal is sealed between a pair of glass substrates. Further, solar cells such as an organic thin-film solar cell and a die-sensitized solar cell also have a structure in which a solar cell element (a photoelectric conversion element) is sealed between a pair of glass substrates.

For sealing, a sealing glass is suitably used. In sealing by the sealing glass, for example, a pre-baked layer is obtained by baking a sealing material containing a sealing glass onto a surface of one of glass substrates in a frame shape, that glass substrate and the other glass substrate are overlapped via the pre-baked layer, and thereafter, the pre-baked layer is made into a sealing layer by being heated to 400 to 600° C.

As the sealing glass, there are known a Bi₂O₃—B₂O₃ based glass, a V₂O₅ based glass, and the like, and since having a low softening point and low influence to an environment and a human body, the Bi₂O₃—B₂O₃ based glass is suitably used. As the Bi₂O₃—B₂O₃ based glass, one whose adhesive strength is improved is known (for example, refer to Patent Reference 1 (WO 2010/067848 A1)).

However, in an element substrate on which an electronic element is mainly mounted of the pair of glass substrates, a passivation film is sometimes provided in a manner to cover the electronic element for the purpose of insulation, protection and the like of the electronic element. The passivation film can be provided in a manner to cover only the electronic element, by masking a portion other than the electronic element at a time of formation of the passivation film, or by removing a film made on a portion other than the electronic element after formation of the passivation film. However, by either of method of masking at the time of film formation and the method of removing after film formation, productivity is reduced due to increase of process steps. Thus, in general, a passivation film is provided in a manner to cover an entire surface of an element substrate including a portion other than an electronic element. As the passivation film, nitride films such as a silicon nitride film and a silicon oxynitride film can be cited (for example, refer to Patent Reference 2 (WO 2011/004567 A1, Patent Reference 3 (JP-A 2007-200890), and Patent Reference 4 (JP-A 2011-70796)).

### SUMMARY

As described above, a Bi₂O₃—B₂O₃ based glass is suitably used as a sealing glass. However, if a nitride film as a passivation film exists in a region in which a sealing layer is to be provided, there is a possibility that the nitride film and the sealing glass react at a time of sealing, generating foaming of nitride in a sealing layer, so that a sufficient adhesive strength cannot be obtained. Though it is also considered to use a V₂O₅ based glass as a sealing glass, an adhesive strength thereof is generally smaller compared with that of the Bi₂O₃—B₂O₃ based glass. The present invention is made in order to solve such a problem, and its object is to provide a glass composition in which foaming due to a reaction with a nitride film is suppressed, and a sealing material and a sealed package which use the same.

A glass composition of the present invention contains, in mole percentage based on following oxides, 30% to 90% of TeO₂, 0% to 60% of ZnO, 0% to 24% of B₂O₃, 0% to 8% of Li₂O+Na₂O+K₂O, 0% to 8% of Al₂O₃, 0% to 17% of Bi₂O₃, 0% to 30% of V₂O₅, and 0% to 10% of SiO₂; and does not substantially contain any of components having F, Pb, Cd, W, Mo, Ag, or Gd.

A sealing material of the present invention contains the glass composition of the present invention.

A sealed package of the present invention has a first substrate, a second substrate, and a sealing layer. The second substrate is disposed to face the first substrate. The sealing layer is disposed between the first substrate and the second substrate and bonds the first substrate and the second substrate. The sealing layer is a layer formed by the sealing material of the present invention being melted and solidified.

According to the present invention, it is possible to provide a glass composition in which foaming by a reaction with a nitride film is suppressed. According to such a glass composition, by using the glass composition for sealing of a substrate which has a nitride film, foaming in a sealing layer can be suppressed and an adhesive strength can be improved.

### BRIEF DESCRIPTION OF THE DRAWINGS

FIG. 1 is a front view showing an embodiment of a sealed package.

FIG. 2 is a cross-sectional view taken along a line A-A of the sealed package shown in FIG. 1.

FIG. 3A is a process drawing showing an embodiment of a method for manufacturing the sealed package.

FIG. 3B is a process drawing showing the embodiment of the method for manufacturing the sealed package.

FIG. 3C is a process drawing showing the embodiment of the method for manufacturing the sealed package.

FIG. 3D is a process drawing showing the embodiment of the method for manufacturing the sealed package.

FIG. 4 is a plan view of a first substrate used for manufacturing the sealed package shown in FIG. 1.

FIG. 5 is a cross-sectional view taken along a line B-B of the first substrate shown in FIG. 4;

FIG. 6 is a plan view of a second substrate used for manufacturing the sealed package shown in FIG. 1.

FIG. 7 is a cross-sectional view taken along a line C-C of the second substrate shown in FIG. 6.

FIG. 8 is a plan view of one of substrates used for manufacturing a test piece of an example.

FIG. 9 is a cross-sectional view taken along a line D-D of the substrate shown in FIG. 8.

FIG. 10 is a plan view of the other substrate used for manufacturing the test piece of the example.

FIG. 11 is a cross-sectional view taken along a line E-E of the substrate shown in FIG. 10.

FIG. 12 is a cross-sectional view showing the test piece of the example.

FIG. 13 is a plan view of a test piece in which supporting bodies are provided in both surfaces.

FIG. 14 is a cross-sectional view taken along a line F-F of the test piece in which the supporting bodies are provided shown in FIG. 13.

FIG. 15 is a drawing showing a method for measuring an adhesive strength.

### DETAILED DESCRIPTION

Hereinafter, an embodiment for implementing the present invention will be described. A glass composition of the present invention contains, in mole percentage based on following oxides, 30% to 90% of TeO₂, 0% to 60% of ZnO, 0% to 24% of B₂O₃, 0% to 8% of Li₂O+Na₂O+K₂O, 0% to 8% of Al₂O₃, 0% to 17% of Bi₂O₃, 0% to 30% of V₂O₅, and 0% to 10% of SiO₂. Further, the glass composition of the present invention does not substantially contain any of components which includes F, Pb, Cd, W, Mo, Ag, or Gd. In the present specification, “not substantially contain” does not exclude mixing by an impurity. However, mixing by the impurity is preferable to be less than 0.03 mol %, and is more preferable to be 0.01 mol % or less. Further, simple notation of “%” of each component of the glass composition means “mol %” based on oxide, as long as not stated specifically.

According to the glass composition of the present invention, a reaction with a nitride film is suppressed compared with a conventional Bi₂O₃ based glass. For example, a reaction of SiNₓ with Bi₂O₃ or TeO₂ is represented as below.

2Bi₂O₃+3SiNₓ→4Bi+3SiO₂+3x/2N₂

2TeO₂+2SiNₓ→2Te+2SiO₂+xN₂

As is obvious from reaction formulas above, when amounts of Bi₂O₃ and TeO₂ are the same, an amount of SiNₓ to react with TeO₂ is smaller. Thereby, it is supposed that excessive generation of a reaction layer is suppressed, the reaction layer formed by such a reaction in a neighborhood of an interface between the nitride film and a sealing material layer at a sealing time, and that, consequently, foaming of N₂ in a sealing layer is suppressed.

Further, since TeO₂ has lower compatibility to Si and Si component is hard to be taken into a glass, the above-described reaction is hard to proceed. Thereby, it is supposed that the reaction layer of an amount necessary for adhesion is formed but that excessive formation is suppressed, foaming being further suppressed.

Therefore, by using the glass composition of the present invention to seal a substrate having a nitride film, it is possible to improve an adhesive strength compared with a conventional Bi₂O₃ based glass. Note that though a silicon nitride film (SiNₓ), a silicon oxynitride film (a SiOₓN_{y} film), and the like can be cited as the nitride film, the nitride film is not necessarily limited to the above as long as the nitride film contains nitrogen.

Hereinafter, a component of the glass composition of the embodiment according to the present invention will be described.

TeO₂ is a glass forming oxide and forms a network of a glass. When a content of TeO₂ is small, a softening point of a glass composition becomes high, making sealing at a low temperature difficult. On the other hand, when the content of TeO₂ is large, vitrification becomes difficult and a thermal expansion coefficient becomes large. Thus, the content of the TeO₂ is preferable to be 30% or more, is more preferable to be 33% or more, and is further preferable to be 35% or more, in the glass composition. Further, the content of the TeO₂ is preferable to be 90% or less, is more preferable to be 85% or less, and is further preferable to be 80% or less, in the glass composition.

ZnO is a component to reduce a thermal expansion coefficient. However, a large content of ZnO reduces stability of a glass and makes devitrification apt to occur. Thus, the content of ZnO is preferable to be 0% or more, is more preferable to be 3% or more, and is further preferable to be 5% or more, in a glass composition. Further, the content of ZnO is preferable to be 60% or less, is more preferable to be 50% or less, and is further preferable to be 45% or less, in the glass composition.

B₂O₃ is a glass forming oxide and facilitates vitrification in combination with TeO₂. However, a large content of B₂O₃ heightens a softening point, making sealing at a low temperature difficult. Further, a water resistance is reduced, and a material strength of a glass is reduced, to lead to reduction of an adhesive strength. Thus, a content of B₂O₃ is preferable to be 0% or more, is more preferable to be 3% or more, and is further preferable to be 5% or more, in a glass composition. Further, the content of B₂O₃ is preferable to be 24% or less, is more preferable to be 23% or less, and is further preferable to be 21% or less, in the glass composition.

LiO₂, Na₂O, and K₂O are effective as low-softening components. However, when a total content thereof becomes large, there is a possibility of devitrification or phase splitting of a glass. Further, since a water resistance and an acid resistance of a glass are worsened, it is desirable that the above components are not contained wherever possible. The total content of the above components is preferable to be 8% or less, is more preferable to be 5% or less, and is further preferable to be 3% or less, in a glass composition.

Al₂O₃ is a component facilitating vitrification in combination with TeO₂. However, a large content of Al₂O₃ makes a softening point too high, making sealing at a low temperature difficult, and there is a possibility that vitrification does not occur. Thus, the content of Al₂O₃ is preferable to be 0% or more, is more preferable to be 0.5% or more, and is further preferable to be 1% or more, in a glass composition. Further, the content of Al₂O₃ is preferable to be 8% or less, is more preferable to be 7% or less, and is further preferable to be 6% or less, in the glass composition.

Bi₂O₃ is a glass forming oxide, facilitates vitrification in combination with TeO₂, and is effective as a low-softening component. However, when a content of Bi₂O₃ becomes too large, a reaction between a nitride film and a glass composition proceeds excessively and there is a possibility of foaming. Thus, it is preferable to contain Bi₂O₃ to a degree suppressing reactivity between the nitride film and the glass composition and not causing foaming. On the other hand, when an adhesive strength is low due to a low reaction between the nitride film and the glass composition, it is preferable to contain Bi₂O₃ to a degree not causing foaming, to improve reactivity.

In particular, in a case where a glass composition contains a large amount of V₂O₅, a material strength and reactivity of a glass can be improved by containing Bi₂O₃, so that an adhesive strength can be made large. For such reasons, the content of Bi₂O₃ is 17% or less in a glass composition.

In a case where V₂O₅ is not contained, the content of Bi₂O₃ is preferable to be 0% or more, is more preferable to be 2% or more, and is further preferable to be 3% or more, in a glass composition. Further, the content of Bi₂O₃ is preferable to be 17% or less, is more preferable to be 12% or less, and is further preferable to be 10% or less, in the glass composition.

In a case where V₂O₅ is contained, a content of Bi₂O₃ is preferable to be 1% or more, is more preferable to be 5% or more, and is further preferable to be 10% or more, in a glass composition. Further, the content of Bi₂O₃ in the case where V₂O₅ is contained is preferable to be 17% or less, is more preferable to be 16% or less, and is further preferable to be 15% or less, in the glass composition.

V₂O₅ is a glass forming oxide and forms a network of a glass, and is also effective as a low-softening component. However, a large content of V₂O₅ reduces material strength of a glass. Further, V₂O₅ is also effective as a laser absorbing component, but is easy to be oxidation-reduced by an atmosphere at a dissolving time, making control of a valence number of a V ion difficult and absorbance of a laser light unstable, and there is a possibility that sealing becomes unstable thereby. Thus, it is possible that the content of V₂O₅ is 0%, but if contained, the content thereof is preferable to be 5% or more, is more preferable to be 10% or more, and is further preferable to be 20% or more. Further, if V₂O₅ is contained, the content of V₂O₅ is preferable to be 30% or less, is more preferable to be 29% or less, is further preferable to be 28% or less, in a glass composition.

SiO₂ is a glass forming oxide, is a component forming a network of a glass, and is a component improving a material strength of the glass. However, when a content of SiO₂ becomes large, there is a possibility that the glass is phase-split. Thus, the content of SiO₂ is preferable to be 0% or more, is more preferable to be 0.3% or more, and is further preferable to be 0.5% or more, in a glass composition. Further, the content of SiO₂ is preferable to be 10% or less, is more preferable to be 5% or less, and is further preferable to be 3% or less, in the glass composition.

Since F, PbO, and CdO are each environmental pollutants, a glass composition does not substantially contain the above.

Since WO₃ and MoO₃ may each devitrify a glass, a glass composition does not substantially contain the above.

Since Ag₂O is quite expensive as a material and may reduce an insulation characteristic of a glass, a glass composition does not substantially contain Ag₂O. Since Gd₂O₃ is quite expensive as a material, a glass composition does not substantially contain Gd₂O₃.

MgO, CaO, BaO, and SrO facilitate vitrification in combination with TeO₂. However, a large content of MgO, CaO, BaO, and SrO reduces stability of a glass, making devitrification apt to occur. Thus, a total content thereof is preferable to be 0 to 30% in a glass composition. The total content is more preferable to be 0 to 15%, and is further preferable to be 0 to 10%.

A glass composition may contain, other than the above-described components, Fe₂O₃, CoO, CuO, CeO₂, Nb₂O₃, Ta₂O₅, Sb₂O₃, Cs₂O, P₂O₅, TiO₂, ZrO₂, La₂O₃, SnOₓ (x is “1” or “2”), or the like as an arbitrary component. However, when a content of the arbitrary component is large, there is a possibility that a glass becomes unstable to cause devitrification, or that a glass transition point or a softening point rise, and thus a total amount of the arbitrary components is preferable to be 10% or less.

Among the above, Fe₂O₃, CoO, CuO, and CeO₂ are also effective as laser absorbing components, but are easy to be oxidation-reduced by an atmosphere at a dissolving time, and thus, there is a possibility that control of a valence number becomes difficult, leading to unstable absorption of a laser light, and thereby, there is a possibility that sealing becomes unstable.

Thus, it is possible that a content of Fe₂O₃, CoO, CuO, and CeO₂ is 0%, but if contained, the content is preferable to be 0.05% or more per each component, is more preferable to be 0.1% or more, and is further preferable to be 0.2% or more. Further, with regard to the content in a case where Fe₂O₃, CoO, CuO, and CeO₂ are contained, a total amount thereof is preferable to be 10% or less, is more preferable to be 5% or less, and is further preferable to be 3% or less, in a glass composition.

Among the above, CuO also has an effect, other than the above, to improve a debinding characteristic in a pre-baking process step in which a binder component is removed after a paste is dried. It is possible that a content of CuO is 0%, but if the effect to improve debinding characteristic is aimed at, the content is preferable to be 0.05% or more, is more preferable to be 0.1% or more, and is further preferable to be 0.2% or more. Further, the content thereof is preferable to be 10% or less, is more preferable to be 5% or less, and is further preferable to be 3% or less, in a glass composition.

The glass compositions of the embodiment according to the present invention can be classified broadly into one which does not substantially contain V₂O₅ and one which contains V₂O₅. Hereinafter, a preferable composition in each case will be presented.

The glass composition which does not substantially contain V₂O₅ is preferable to contain, in mole percentage based on following oxides, 30 to 90% of TeO₂, 0 to 60% of ZnO, 0 to 24% of B₂O₃, 0 to 8% of Li₂O+Na₂O+K₂O, 0 to 8% of Al₂O₃, 0 to 17% of Bi₂O₃, and 0 to 10% of SiO₂.

A content of TeO₂ is preferable to be 30% or more, is more preferable to be 35% or more, and is further preferable to be 45% or more. The content of TeO₂ is preferable to be 90% or less, is more preferable to be 80% or less, and is further preferable to be 70% or less.

A content of ZnO is preferable to be 0% or more, is more preferable to be 5% or more, and is further preferable to be 10% or more. The content of ZnO is preferable to be 60% or less, is more preferable to be 45% or less, and is further preferable to be 35% or less.

A content of B₂O₃ is preferable to be 0% or more, is more preferable to be 3% or more, and is further preferable to be 5% or more. The content of B₂O₃ is preferable to be 24% or less, is more preferable to be 22% or less, and is further preferable to be 20% or less.

It is desirable that Li₂O, Na₂O, and K₂O are not contained wherever possible, and a total content thereof is preferable to be 8% or less, is more preferable to be 5% or less, and is further preferable to be 3% or less, in a glass composition.

A content of Al₂O₃ is preferable to be 0% or more, is more preferable to be 0.5% or more, and is further preferable to be 1% or more. The content of Al₂O₃ is preferable to be 8% or less, is more preferable to be 7% or less, and is further preferable to be 6% or less.

A content of Bi₂O₃ is preferable to be 0% or more, is more preferable to be 2% or more, and is further preferable to be 3% or more. The content of Bi₂O₃ is preferable to be 17% or less, is more preferable to be 10% or less, and is further preferable to be 6% or less.

A content of SiO₂ is preferable to be 0% or more, is more preferable to be 0.3% or more, and is further preferable to be 0.5% or more. The content of SiO₂ is preferable to be 10% or less, is more preferable to be 5% or less, and is further preferable to be 3% or less.

A glass composition which does not substantially contain V₂O₅ is more preferable to be one which contains, for example, 45 to 70% of TeO₂, 10 to 35% of ZnO, 3 to 22% of B₂O₃, 0 to 3% of Li₂O+Na₂O+K₂O, 0 to 6% of Al₂O₃, 2 to 6% of Bi₂O₃, and 0 to 3% of SiO₂.

The glass composition which does not substantially contain V₂O₅ is further preferable to be one which contains, for example, 45 to 70% of TeO₂, 10 to 35% of ZnO, 3 to 22% of B₂O₃, 0 to 3% of Li₂O+Na₂O+K₂O, 0.5 to 6% of Al₂O₃, 2 to 6% of Bi₂O₃, and 0 to 3% of SiO₂.

On the other hand, in a case of the glass composition which contains V₂O₅, it is preferable to contain, in mole percentage based on following oxides, 45 to 80% of TeO₂, 1 to 17% of Bi₂O₃, and 5 to 30% of V₂O₅.

A content of TeO₂ is preferable to be 45% or more, is more preferable to be 50% or more, and is further preferable to be 55% or more. The content of TeO₂ is preferable to be 80% or less, is more preferable to be 70% or less, and is further preferable to be 65% or less.

A content of Bi₂O₃ is preferable to be 1% or more, is more preferable to be 5% or more, and is further preferable to be 10% or more. The content of Bi₂O₃ is preferable to be 17% or less, is more preferable to be 16% or less, and is further preferable to be 15% or less.

A content of V₂O₅ is preferable to be 5% or more, is more preferable to be 15% or more, and is further preferable to be 25% or more. The content of V₂O₅ is preferable to be 30% or less, is more preferable to be 29% or less, and is further preferable to be 28% or less.

A glass composition which contains V₂O₅ is more preferable to be one which contains 45 to 65% of TeO₂, 10 to 15% of Bi₂O₃, and 25 to 30% of V₂O₅, for example.

Note that, MgO, CaO, BaO, and SrO can be contained in any composition regardless of existence/absence of V₂O₅, and a total content thereof is preferable to be 0 to 30%, is more preferable to be 0 to 15%, and is further preferable to be 0 to 10%. Further, Fe₂O₃, COO, CuO, CeO₂, Nb₂O₃, Ta₂O₅, Sb₂O₃, Cs₂P, P₂O₅, TiO₂, ZrO₂, La₂I₃, SnOₓ (x is “1” or “2”), and the like can be contained, and a total content thereof is preferable to be 10% or less.

A glass transition point of the glass composition of the embodiment of the present invention is about 280 to 410° C., and a softening point is about 320 to 500° C. Further, a thermal expansion coefficient is about 90×10⁻⁷/° C. to 150×10⁻⁷/° C. Those physical property values of the glass composition of the embodiment are included in a range suitable as a sealing glass.

The glass composition of the embodiment according to the present invention can be in a bulk form, a powder form, or the like, the form thereof not being limited in particular. The glass composition of the embodiment according to the present invention is suitable as a sealing glass, and is suitable in particular for sealing of a substrate having a nitride film as a passivation film or the like in a surface. As the nitride films, a SiNₓ film, a SiOₓN_{y} film and so on can be cited, but the nitride film is not limited thereto as long as the nitride film includes nitrogen.

The nitride film is not necessarily limited to one existing in an uppermost surface of a substrate. In other words, a surface of a sealing side of the nitride film can be covered by another film. There is a possibility of foaming also in the nitride film covered by another film as above, by using a conventional glass composition. As another film, there can be cited a SiO₂ film, an Al₂O₃ film, a TiO₂ film, a Ta₂O₅ film, a HfO₂ film and so on, and it is possible that only one layer of the above films is provided or that two or more layers of the above films are stacked and provided.

Next, a sealed package to which the glass composition of the embodiment according to the present invention is applied will be described.

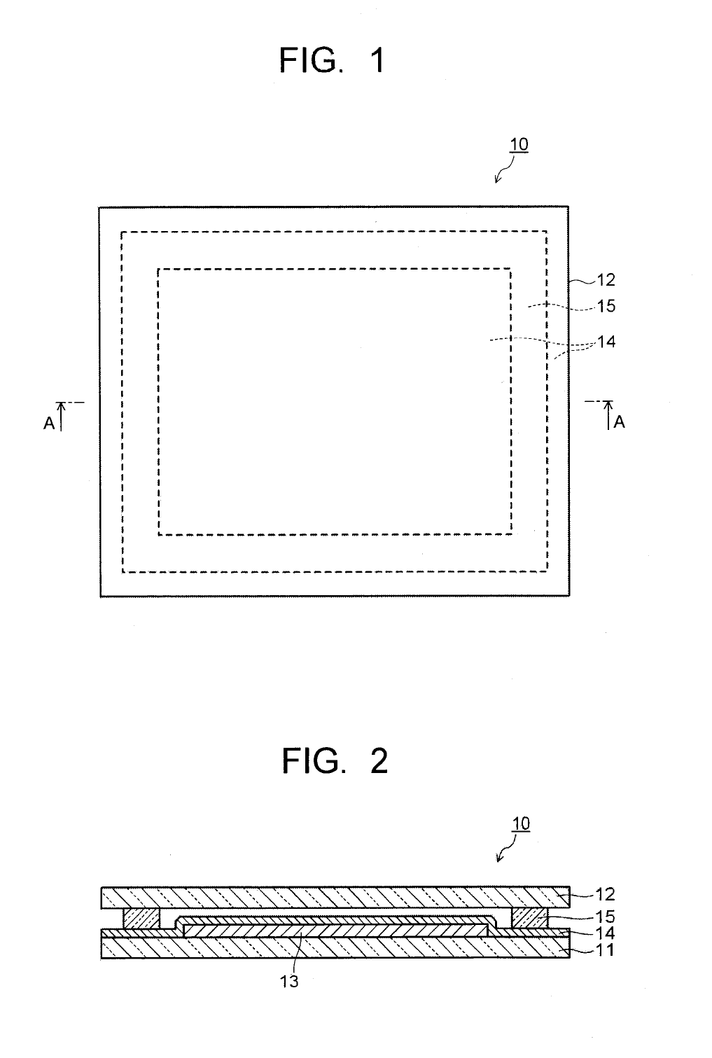

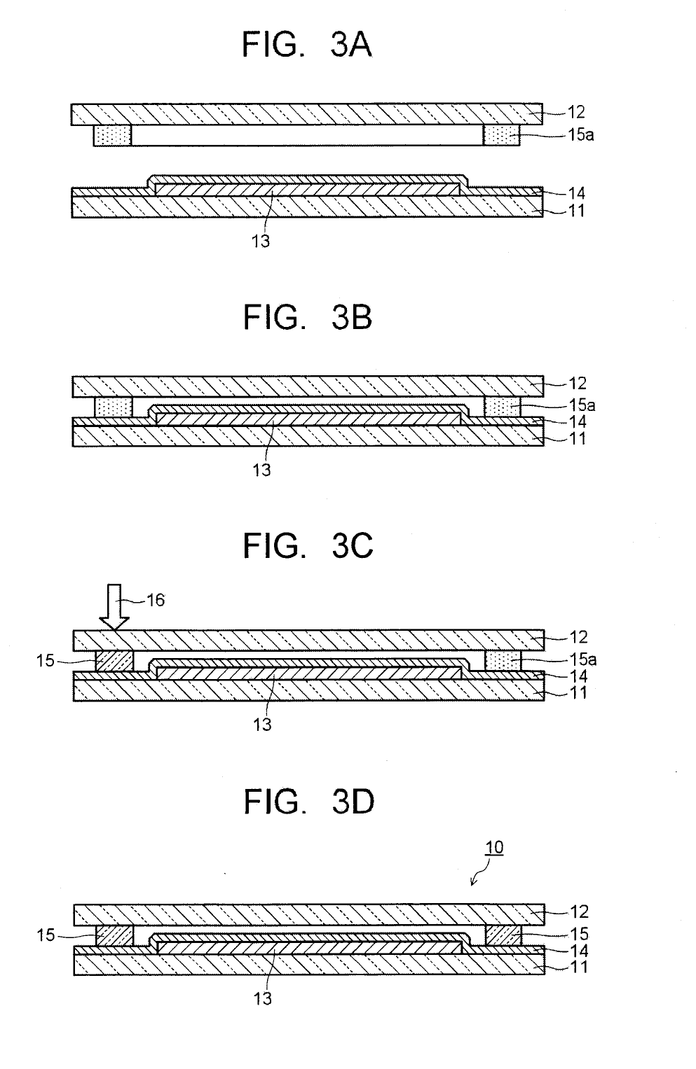

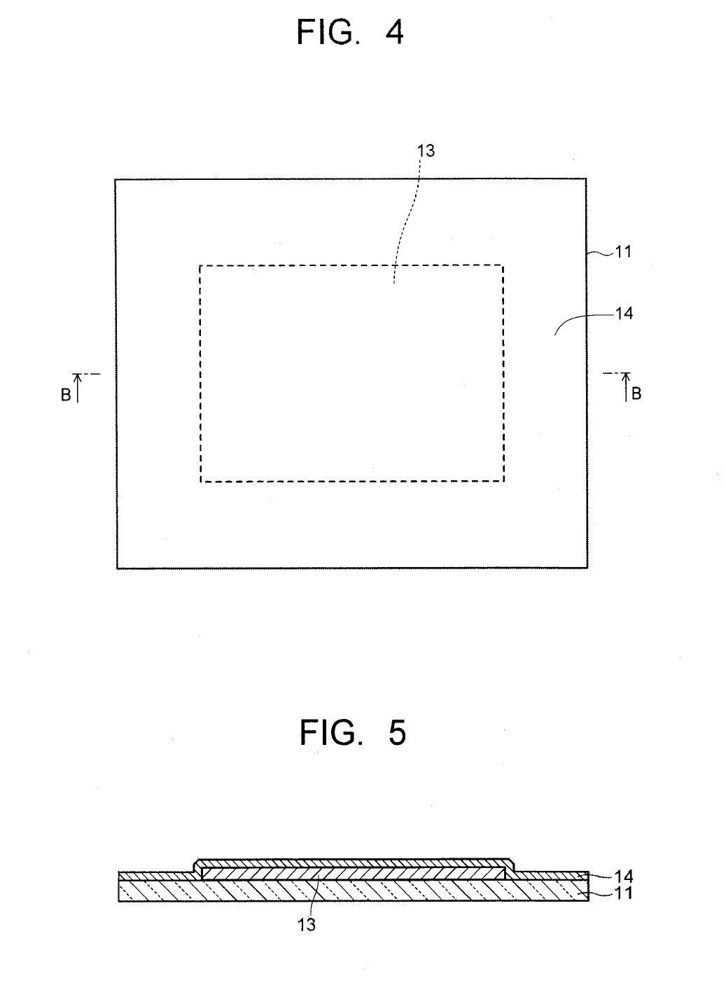

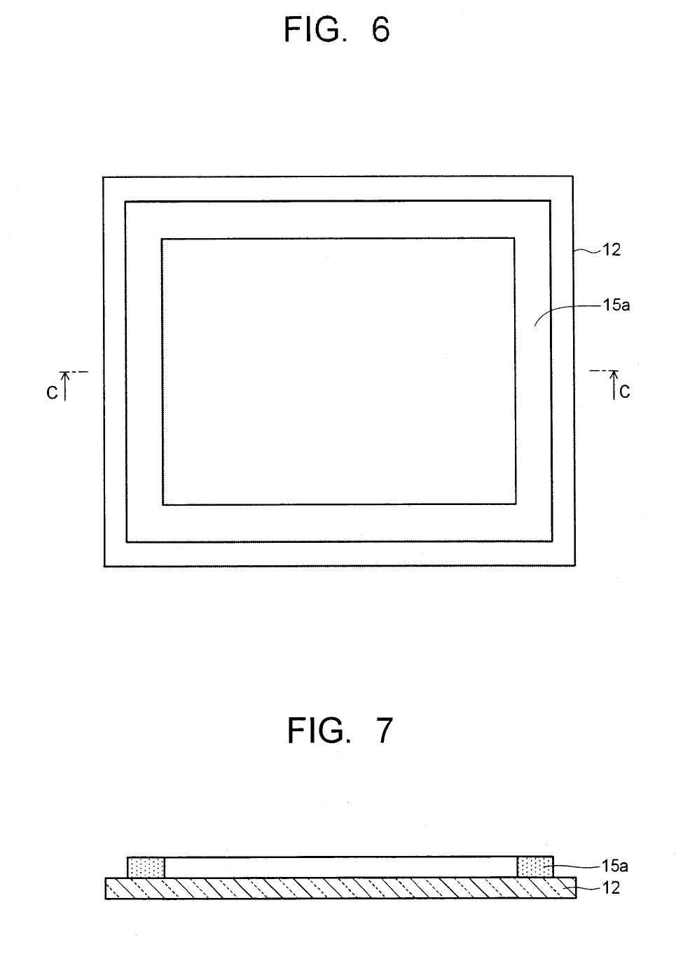

FIG. 1 and FIG. 2 are a front view and a cross-sectional view showing an embodiment of the sealed package. FIG. 3A to FIG. 3D are process drawings showing an embodiment of a method for manufacturing the sealed package shown in FIG. 1. FIG. 4 and FIG. 5 are a plan view and a cross-sectional view of a first substrate used for manufacturing the sealed package shown in FIG. 1 and FIG. 2. FIG. 6 and FIG. 7 are a plan view and a cross-sectional view of a second substrate used for manufacturing the sealed package shown in FIG. 1 and FIG. 2.

A sealed package 10 constitutes a FPD such an OELD, a PDP, or a LCD, a lighting device (an OEL lighting or the like) in which a light emitting element such as an OEL element is used, a solar cell such as a die-sensitized solar cell, or the like. The sealed package 10 has a first substrate 11, a second substrate 12, an electronic element part 13, a nitride film 14, and a sealing layer 15.

The first substrate 11 is an element substrate in which the electronic element part 13 is mainly provided, for example. The second substrate 12 is a sealing substrate mainly used for sealing, for example. The first substrate 11 is provided with the electronic element part 13 and is provided with the nitride film 14 in a manner to cover an entire surface including a surface of the electronic element part 13. The first substrate 11 and the second substrate 12 are disposed to face each other, and are bonded by the sealing layer 15 disposed in a frame shape therebetween.

For the first substrate 11 and the second substrate 12, a soda lime glass substrate, a non-alkali glass substrate, and the like are used. As the soda lime glass substrate, there can be cited AS, PD200 (both are manufactured by ASAHI GLASS CO., LTD., trade names), and one which is chemically strengthened, for example. Further, as the non-alkali glass substrate, there can be cited AN100 (manufactured by ASAHI GLASS CO., LTD., trade name), EAGEL 2000 (manufactured by Corning Incorporated, trade name), EAGEL GX (manufactured by Corning Incorporated, trade name), JADE (manufactured by Corning Incorporated, trade name), #1737 (manufactured by Corning Incorporated, trade name), OA-10 (manufactured by Nippon Electric Glass Co., Ltd., trade name), TEMPAX (manufactured by SCHOTT AG, trade name), and the like, for example.

The electronic element part 13, in a case of the OELD or the OEL lighting, has an OEL element, in a case of the PDP, has a plasma light-emitting element, in a case of the LCD, has a liquid crystal display element, and in a case of the solar cell, has a die-sensitized solar cell element (die-sensitized photoelectric conversion part element), for example. The electronic element part 13 can have a variety of known structures, and is not limited to a shown structure.

In the sealed package 10 of FIG. 1 and FIG. 2, the OEL element, the plasma light-emitting element, or the like is provided on the substrate 11, as the electronic element part 13. In the case where the electronic element part 13 is the die-sensitized solar cell element or the like, an element film such as a wiring film, or an electrode film, is provided on an opposite surface of each of the first substrate 11 and the second substrate 12, though not shown.

The nitride film 14 is provided as a passivation film for the purpose of insulation, protection, or the like of the electronic element part 13, for example. As the nitride film 14, there can be cited a silicon nitride film (SiNₓ film), a silicon oxynitride film (SiOₓN_{y} film) and the like, but the nitride film 14 is not necessarily limited thereto. Even if the nitride film 14 exists in a surface of the first substrate 11, according to the sealing layer 15 formed by a sealing material which contains the glass composition of the embodiment according to the present invention being melted and solidified, foaming at a time of sealing is suppressed, so that an adhesive strength is improved. A thickness of the nitride film 14 is not necessarily limited, but an effect to suppress foaming becomes prominent in a case of 50 nm or more. The thickness of the nitride film 14 is generally preferable to be 1000 nm or less.

In the case where the electronic element part is the OEL element or the like, a space partially remains between the first substrate 11 and the second substrate 12. This space can be left as it is, or a transparent resin or the like can be filled thereinto. The transparent resin can be bonded to the first substrate 11 and the second substrate 12, or can just contact the first substrate 11 and the second substrate 12.

In the case where the electronic element part 13 is the die-sensitized solar cell element or the like, the electronic element part 13 is disposed in the entire between the first substrate 11 and the second substrate 12, though not shown. Note that what is sealed is not limited to the electronic element part 13 and can be a photoelectric conversion device or the like. Further, the sealed package 10 can be a building material such as a double glass which does not have an electronic element part 13.

The sealing layer 15 can be obtained by melting and solidifying a sealing material layer containing the glass composition of the embodiment according to the present invention as the sealing glass. The sealing material layer to become the sealing layer 15 contains, in addition to the glass composition of the embodiment according to the present invention as the sealing glass, a low-expansion filler and/or a laser absorbent, as necessary.

Next, a method for manufacturing the sealed package 10 will be described. First, the sealing material used for forming the sealing layer 15 will be described.

The sealing material contains the glass composition of the embodiment of the present invention as the sealing glass. A content of the glass composition in the sealing material is preferable to be 55 to 100 vol %, and is more preferable to be 60 to 95 vol %. The sealing material contains, in addition to the glass composition, the low-expansion filler and/or the laser absorbent, as necessary or depending on a sealing method.

The low-expansion filler has a thermal expansion coefficient lower than that of the above-described glass composition, and has a thermal expansion coefficient of about −15×10⁻⁷/° C. to 45×10⁻⁷/° C. The low-expansion filler is contained for the purpose of reducing a thermal expansion coefficient of the sealing layer 15.

It is preferable that the low-expansion filler is at least one kind selected from a silica, an alumina, a zirconia, a zirconium silicate, a cordierite, a zirconium phosphate-based compound, a soda lime glass, and a borosilicate glass. As the zirconium phosphate-based compound, there can be cited (ZrO)₂P₂O₇, NaZr₂(PO₄)₃, KZr₂(PO₄)₃, Ca_{0.5}Zr₂(PO₄)₃, NbZr(PO₄)₃, Zr₂(WO³)(PO₄)₂, and a complex compound thereof.

A maximum grain diameter of the low-expansion filler is generally smaller than a thickness of a later-described pre-baked layer to be the sealing layer 15 by heating. A film thickness of the pre-baked layer is decreased by heating, but its decrease rate is low, and thus the thickness of the pre-baked layer is preferable to be about 100 to 120% of a thickness of the sealing layer. Since the thickness of the sealing layer is normally 10 μm or less, the thickness of the pre-baked layer is normally 12 μm or less. The thickness of the sealing layer is not limited in particular, but is preferably about 2 μm to 7 μm.

Therefore, in order to form such a pre-baked layer, the maximum grain diameter of the low-expansion filler is preferable to be 1 μm to 10 μm. Note that an average grain diameter (D₅₀) of the low-expansion filler is preferable to be 0.1 μm to 2.0 μm. “D₅₀” is a value measured by using a laser diffraction scattering method. Note that the glass composition which the sealing material contains is also preferable to have a maximum grain diameter and an average grain diameter (D₅₀) similar to those of the low-expansion filler.

A content of the low-expansion filler is set so that the thermal expansion coefficient of the sealing layer 15 becomes close to thermal expansion coefficients of the first substrate 11 and the second substrate 12. The content of the low-expansion filler is preferable to be 1 to 50 vol % in the sealing material, depending on the thermal expansion coefficients of the first substrate 11, the second substrate 12, the sealing glass, and the like. Further, a volume fraction of the low-expansion filler in relation to the glass composition in the sealing material is preferable to be 1/99 to 50/50.

As the laser absorbent, there can be cited at least one kind of metal selected from Fe, Cr, Mn, Co, Ni, and Cu, or a chemical compound (an inorganic pigment) such as an oxide which contains that metal. Further, the laser absorbent can be a pigment other than the above.

A maximum grain diameter of the laser absorbent is generally smaller than the thickness of the pre-baked layer to be the sealing layer 15 by heating. The film thickness of the pre-baked layer is decreased by heating, but its decrease rate is low, and thus the thickness of the pre-baked layer is preferable to be about 100 to 120% of the thickness of the sealing layer. The thickness of the pre-baked layer is normally 12 μm or less. Therefore, in order to form such a pre-baked layer, the maximum grain diameter of the laser absorbent is preferable to be 1 μm to 10 μm. Note that an average grain diameter (D₅₀) of the laser absorbent is preferable to be 0.1 μm to 2.0 μm.

A content of the laser absorbent is preferable to be 0.1 to 20 vol % in the sealing material. When the content of the laser absorbent is too small, there is a possibility that sufficient melting of the sealing material by laser irradiation becomes difficult. The content of the laser absorbent is preferable to be 0.1 vol % or more, is more preferable to be 1 vol % or more, and is further preferable to be 3 vol % or more. When the content of the laser absorbent is too large, a fluidity of the sealing material at a melting time becomes bad, thereby an adhesive strength being reduced, and thus the content of the laser absorbent is preferable to be 20 vol % or less, is more preferable to be 18 vol % or less, and is further preferable to be 15 vol % or less.

The sealing material is generally mixed with a vehicle and made into a sealing material paste.

As the vehicle, one obtained by dissolving a resin being a binder component into a solvent is used, for example. Concretely, there can be cited one obtained by dissolving methyl cellulose, ethyl cellulose, carboxymethyl cellulose, oxyethyl cellulose, benzyl cellulose, propyl cellulose, nitro cellulose, or the like into a solvent such as terpineol, texanol, butyl carbitol acetate, or ethyl carbitol acetate, one obtained by dissolving an acrylic resin such as methyl (meta)acrylate, ethyl (meta) acrylate, buthyl (meta)acrylate, or 2-hydroxy ethyl (meta) acrylate into a solvent such as methyl ethyl ketone, terpineol, texanol, butyl carbitol acetate, or ethyl carbitol acetate, and one obtained by dissolving polyalkylene carbonate such as polyethylene carbonate, or polypropylene carbonate into a solvent such as triethyl acetyl citrate, propylene glycol diacetate, diethyl succinate, ethyl carbitol acetate, triacetin, texanol, dimethyl adipate, ethyl benzoate, or a mixture of propylene glycol mono phenyl ether and triethylene glycol dimethyl ether.

It suffices that a viscosity of the sealing material paste is a viscosity corresponding to a coating apparatus, and the viscosity is adjusted according to a ratio of the sealing material to the vehicle, or a ratio of the solvent to the resin in the vehicle. The sealing material paste can contain an additive such as a defoaming agent, or a dispersing agent in the known glass paste. Preparation of the sealing material paste is carried out by a known method using a rotation type blending machine which has a stirring blade, a roll mill, a ball mill, or the like.

The sealing material paste, after applied on the second substrate 12 in a frame shape, is dried to be a coating layer. As an application method, there can be cited printing methods such as screen printing and gravure printing, a dispensing method, and so on. Drying is performed to remove the solvent, and is normally performed at a temperature of 120° C. or higher for 10 minutes or more. When the solvent remains in the coating layer, there is a possibility that a binder component is not removed sufficiently in pre-baking thereafter.

The coating layer is subjected to pre-baking and made into a pre-baked layer 15a (FIG. 6, FIG. 7). Pre-baking is performed by heating to a temperature of a glass transition point or lower of the sealing glass, to remove the binder component, and thereafter heating to a temperature of a softening point or higher of the sealing glass.

The first substrate 11 is provided with the electronic element part 13 and the nitride film 14, in correspondence with a specification of the sealed package 10 (FIG. 4, FIG. 5). For example, a silicon nitride film (a SiNₓ layer) as the nitride film 14 is formed by CVD methods such as thermal CVD and plasma CVD or by a PVD method such as a sputtering method, in which SiH₄ gas, and at least one kind selected from NH₃ gas and N₂ gas are used. Note that a layer other than the nitride film 14 can be formed in a lower layer and an upper layer of the nitride film 14.

Next, the second substrate 12 in which the pre-baked layer 15a is provided and the first substrate 11 in which the electronic element part 13 and the nitride film 14 are provided are disposed and stacked in a manner that the pre-baked layer 15a and the nitride film 14 face each other (FIG. 3A, FIG. 3B).

Thereafter, baking is performed by irradiating a laser light 16 to the pre-baked layer 15a through the second substrate 12 (FIG. 3C). The laser light 16 is irradiated while scanning along the pre-baked layer 15a of the frame shape. As a result that the laser light 16 is irradiated to an entire circumference of the pre-baked layer 15a, the sealing layer 15 of the frame shape is formed between the first substrate 11 and the second substrate 12. Note that the laser light 16 can be irradiated to the pre-baked layer 15a through the first substrate 11.

The kind of the laser light 16 is not limited in particular, and laser lights such as a semiconductor laser, a carbon dioxide gas laser, an excimer laser, a YAG laser, and a HeNe laser are used. An irradiation condition of the laser light 16 is selected in correspondence with a thickness, a line width, a cross-sectional area in a thickness direction, or the like of the pre-baked layer 15a. An output of the laser light 16 is preferable to be 2 to 150 W. When the output of the laser light is less than 2 W, there is a possibility that the pre-baked layer 15a is not melted. When the output of the laser light exceeds 150 W, a crack or the like is apt to occur in the first substrate 11 or the second substrate 12. The output of the laser light 16 is more preferable to be 5 to 120 W.

As described above, the sealed package 10 in which the electronic element part 13 is hermetic sealed between the first substrate 11 and the second substrate 12 by the sealing layer 15 is manufactured (FIG. 3D). On this occasion, even if the nitride film 14 exists on the first substrate 11, the sealing material used for forming the sealing layer 15 contains the glass composition of the embodiment according to the present invention as the sealing glass, and thus foaming due to a reaction between the nitride film 14 and the sealing glass in the sealing material is suppressed. Thereby, an adhesive strength between the first substrate 11 and the second substrate 12 is improved, and reliability is improved.

Hereinabove, the method for performing baking by irradiation of the laser light 16 is described, but baking is not necessarily limited to by the method performed by irradiation of the laser light 16. As a baking method, another method can be adopted in correspondence with a heat resistance of the electronic element part 13, a configuration of the sealed package 10, or the like. For example, when the heat resistance of the electronic element part 13 is high, or the electronic element part 13 is not had, it is possible that, instead of irradiation of the laser light 16, an entire of an assembly shown in FIG. 3B is disposed in a firing furnace such as an electric furnace and that the entire of the assembly including the pre-baked layer 15a is heated to be the sealing layer 15.

Hereinabove, though the embodiment of the sealed package of the present invention is described with an example, the sealed package of the present invention is not limited thereto. Its configuration can be properly altered without departing from the spirit of the present invention, and as the need arises.

### EXAMPLES

Next, concrete examples of the present invention and evaluation results thereof will be stated. Note that the following explanation is not intended to limit the present invention but modification is possible along the spirit of the present invention.

### Examples 1 to 33, Comparative Examples 1 to 5

Materials are blended to have a composition shown in Tables 1 to 4, put into a platinum crucible and fed to a melting furnace adjusted to be 1000° C., and melted for 30 to 50 minutes. An obtained molten liquid, after formed into a sheet shape by a water-cooling roller, is subjected to dry grinding by a ball mill, and is further subjected to water grinding by a ball mill, so that a slurry is obtained. The slurry is sieved through a sieve of 325 mesh in terms of an opening and subjected to cake filtration, drying, and disintegration by a mesh, being made into a glass composition. When D₅₀ of this glass composition is measured by a Microtrac particle size measuring apparatus (manufactured by NIKKISO CO., LTD.), each D₅₀ is in a range of 0.5 μm to 1 μm.

Next, the following evaluation is performed about those glass compositions. Note that a blank column in a column of composition in Tables 1 to 4 indicates that that component is not substantially contained. In a column of evaluation, “-” indicates that a crystallization peak by DTA is not found and a blank column indicates that measurement is not performed.

(Glass Transition Point “Tg”, Softening Point “Ts”, Crystallization Peak “Tcl”) By DTA (Differential Thermal Analysis), a first inflection point is measured as Tg [° C.], a fourth inflection point is measured as Ts [° C.], and an exothermic peak by crystallization is measured as Tcl [° C.].

(Average Line Thermal Expansion Coefficient α)

A thermal expansion coefficient is measured by a thermomechanical analysis apparatus (TMA8310 manufactured by Rigaku Corporation). In this measurement, a glass composition formed in a powder shape is melted again, slowly cooled, and formed into a round bar of 5 mm in diameter×20 mm in length, an upper and bottom surfaces formed in parallel, to be used as a measurement specimen, and the measurement specimen is heated from a room temperature to 250° C. at 10° C./min, and an average line thermal expansion coefficient “α” between 50° C. to 250° C. is obtained. Further, as a standard sample, a quartz glass is used.

(Vitrification)

As a method for judging vitrification, one in which the material remaining not dissolved is confirmed by visual observation at a time of melting is judged as “undissolved”, one in which phase splitting is found by observation by an optical microscope after the molten liquid is formed into the sheet shape by the water cooling roller is judged as “phase split”, and one which is vitrified without being “undissolved” nor “phase split” is judged as “∘”.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Glass | Composition | SiO₂ | | | | | | 2.8 | | | | | |
| composition | [mol %] | B₂O₃ | 19.2 | 20.4 | 15.0 | 15.0 | 15.0 | 21.0 | 15.0 | 15.0 | 15.0 | 15.0 | 15.0 |
| | | ZnO | 27.6 | 33.3 | | 4.0 | | 31.4 | | 4.0 | 5.0 | 35.0 | 5.0 |
| | | Li₂O | | | | | | | | | | | |
| | | Na₂O | | | | | | | | | | | |
| | | K₂O | | | | | | | | | | | |
| | | MgO | | | 5.0 | 1.0 | 5.0 | | 5.0 | 1.0 | | | |
| | | CaO | | | | | | | | | | | |
| | | BaO | | | | | | | | | | | |
| | | SrO | | | | | | | | | | | |
| | | Al₂O₃ | 1.2 | 1.2 | | | 1.0 | 2.2 | | 1.0 | 1.0 | 1.0 | 1.0 |
| | | Bi₂O₃ | | | 10.0 | 10.0 | 9.0 | | 7.0 | 9.0 | 3.0 | 3.0 | 4.0 |
| | | V₂O₅ | | | | | | | | | | | |
| | | TeO₂ | 52.0 | 45.1 | 70.0 | 70.0 | 70.0 | 42.6 | 73.0 | 70.0 | 76.0 | 46.0 | 75.0 |
| | | CuO | | | | | | | | | | | |

| | | | | | | | | | | | | |
|---|---|---|---|---|---|---|---|---|---|---|---|---|
| | Li₂O + Na₂O + K₂O | | | | | | | | | | | |
| Evaluation | Tg [° C.] | 382 | 396 | 357 | 342 | 356 | 403 | 350 | 350 | 342 | 383 | 346 |
| | Ts [° C.] | 460 | 477 | 424 | 406 | 423 | 486 | 415 | 416 | 409 | 459 | 411 |
| | Tc1 [° C.] | — | — | 502 | 516 | — | — | 529 | — | 477 | 579 | 486 |
| | α [×10⁻⁷/° C.] | | | 142 | 147 | 140 | 101 | | 143 | | | |
| | Vitrification | ◯ | ◯ | ◯ | ◯ | ◯ | ◯ | ◯ | ◯ | ◯ | ◯ | ◯ |

TABLE 2

| | | | Example | | | | | | | | | | |
|---|---|---|---|---|---|---|---|---|---|---|---|---|---|
| | | | 12 | 13 | 14 | 15 | 16 | 17 | 18 | 19 | 20 | 21 | 22 |
| Glass | Composition | SiO₂ | | | | | | | | | | | |
| composition | [mol %] | B₂O₃ | 15.0 | 15.0 | 15.0 | 15.0 | 15.0 | 15.0 | 15.0 | 15.0 | 15.0 | 10.0 | 20.0 |
| | | ZnO | 15.0 | 25.0 | 35.0 | 45.0 | 5.0 | 5.0 | 15.0 | 10.0 | 15.0 | 15.0 | 15.0 |
| | | Li₂O | | | | | | | | | | | |
| | | Na₂O | | | | | | | 3.0 | | | | |
| | | K₂O | | | | | | | | | | | |
| | | MgO | | | | | | | | | | | |
| | | CaO | | | | | | | | | | | |
| | | BaO | | | | | | | | | | | |
| | | SrO | | | | | | | | | | | |
| | | Al₂O₃ | 1.0 | 1.0 | 1.0 | 1.0 | 1.0 | 1.0 | 1.0 | 1.0 | 6.0 | 1.0 | 1.0 |
| | | Bi₂O₃ | 4.0 | 4.0 | 4.0 | 4.0 | 1.0 | | 4.0 | 4.0 | 4.0 | 4.0 | 4.0 |
| | | V₂O₅ | | | | | | | | | | | |
| | | TeO₂ | 65.0 | 55.0 | 45.0 | 35.0 | 78.0 | 79.0 | 65.0 | 70.0 | 60.0 | 70.0 | 60.0 |
| | | CuO | | | | | | | | | | | |

| | | | | | | | | | | | | |
|---|---|---|---|---|---|---|---|---|---|---|---|---|
| | Li₂O + Na₂O + K₂O | | | | | | | 3.0 | | | | |
| Evaluation | Tg [° C.] | 354 | 368 | 385 | 403 | 340 | 340 | 339 | 348 | 375 | 341 | 364 |
| | Ts [° C.] | 424 | 442 | 464 | 482 | 406 | 409 | 420 | 400 | 441 | 398 | 429 |
| | Tc1 [° C.] | — | — | — | — | 453 | 452 | — | 495 | — | — | — |
| | α [×10⁻⁷/° C.] | 137 | | | 101 | | | | 137 | | | |
| | Vitrification | ◯ | ◯ | ◯ | ◯ | ◯ | ◯ | ◯ | ◯ | ◯ | ◯ | ◯ |

TABLE 3

| | | | Example | | | | | | | | | | |
|---|---|---|---|---|---|---|---|---|---|---|---|---|---|
| | | | 23 | 24 | 25 | 26 | 27 | 28 | 29 | 30 | 31 | 32 | 33 |
| Glass | Composition | SiO₂ | | | | | | | | | | | |
| composition | [mol %] | B₂O₃ | 15.0 | 15.0 | 5.0 | | 15.0 | 15.0 | 15.0 | 15.0 | | | 14.9 |
| | | ZnO | 15.0 | 10.0 | 15.0 | 15.0 | 15.0 | 15.0 | 15.0 | 15.0 | | | 14.9 |
| | | Li₂O | | | | | | | | | | | |
| | | Na₂O | | | | | | | | | | | |
| | | K₂O | | | | | | | | | | | |
| | | MgO | | 5.0 | | | | | | | | | |
| | | CaO | | | | | | | 5.0 | | | | |
| | | BaO | | | | | 5.0 | 10.0 | | | | | |
| | | SrO | | | | | | | | 5.0 | | | |
| | | Al₂O₃ | 2.0 | 1.0 | 1.0 | 1.0 | 1.0 | 1.0 | 1.0 | 1.0 | | | 1.0 |
| | | Bi₂O₃ | 4.0 | 4.0 | 4.0 | 4.0 | 4.0 | 4.0 | 4.0 | 4.0 | 11.0 | 15.0 | 4.0 |
| | | V₂O₅ | | | | | | | | | 27.5 | 27.5 | |
| | | TeO₂ | 64.0 | 65.0 | 75.0 | 80.0 | 60.0 | 55.0 | 60.0 | 60.0 | 61.5 | 57.5 | 64.8 |
| | | CuO | | | | | | | | | | | 0.4 |

| | | | | | | | | | | | | |
|---|---|---|---|---|---|---|---|---|---|---|---|---|
| | Li₂O + Na₂O + K₂O | | | | | | | | | | | |
| Evaluation | Tg [° C.] | 359 | 362 | 335 | 322 | 359 | 368 | 368 | 367 | 282 | 282 | 355 |
| | Ts [° C.] | 429 | 424 | 390 | 375 | 424 | 435 | 433 | 433 | 324 | 329 | 403 |
| | Tc1 [° C.] | — | — | 508 | 496 | 530 | — | — | — | — | 419 | 510 |
| | α [×10⁻⁷/° C.] | | | | | | | | | | | 136 |
| | Vitrification | ◯ | ◯ | ◯ | ◯ | ◯ | ◯ | ◯ | ◯ | ◯ | ◯ | ◯ |

TABLE 4

| | | | Comparative Example | | | | |
|---|---|---|---|---|---|---|---|
| | | | 1 | 2 | 3 | 4 | 5 |
| Glass | Composition | SiO₂ | | | | | |
| composition | [mol %] | B₂O₃ | 13.8 | 15.0 | 20.4 | 20.4 | |
| | | ZnO | 13.8 | 15.0 | 33.3 | 33.3 | 3.1 |
| | | Li₂O | | | | | |
| | | Na₂O | 8.3 | | | | |
| | | K₂O | | | | | |
| | | MgO | | | | | |
| | | CaO | | | | | |
| | | BaO | | | | | 17.6 |
| | | SrO | | | | | |
| | | Al₂O₃ | 0.9 | 10.0 | 1.2 | 1.2 | |
| | | Bi₂O₃ | 3.7 | 4.0 | 45.1 | 45.1 | |
| | | V₂O₅ | | | | | 41.8 |
| | | TeO₂ | 59.5 | 56.0 | | | 37.5 |
| | | CuO | | | | | |

| | | | | | | |
|---|---|---|---|---|---|---|
| | Li₂O + Na₂O + K₂O | 8.3 | | | | |
| Evaluation | Tg [° C.] | | | 357 | 357 | 277 |
| | Ts [° C.] | | | 417 | 417 | 314 |
| | Tc1 [° C.] | | | — | — | 372 |
| | α [×10⁻⁷/° C.] | | | | | 142 |
| | Vitrification | Phase split | Undissolved | ◯ | ◯ | ◯ |

### Examples A to I, Comparative Examples A to D

As a glass composition, a laser absorbent, and a low-expansion filler, components shown in Tables 5 to 8 are used, and the components are blended to have a ratio (vol %) shown in Tables 5 to 8, to prepare a sealing material. Separately from the above, as a resin and a solvent, components shown in Tables 5 to 8 are used, and the components are blended to have a ratio (mass %) shown in Tables 5 to 8, to prepare a vehicle. Then, the above sealing material and vehicle are blended at a mass fraction shown in Tables 5 to 8, and diluted and viscosity-adjusted by the solvent shown in Tables 5 to 8 so as to have a viscosity suitable for screen printing, to prepare a sealing material paste. Note that D₅₀ of the laser absorbent is 0.8 μm, and D₅₀ of the low-expansion filler is 0.9 μm.

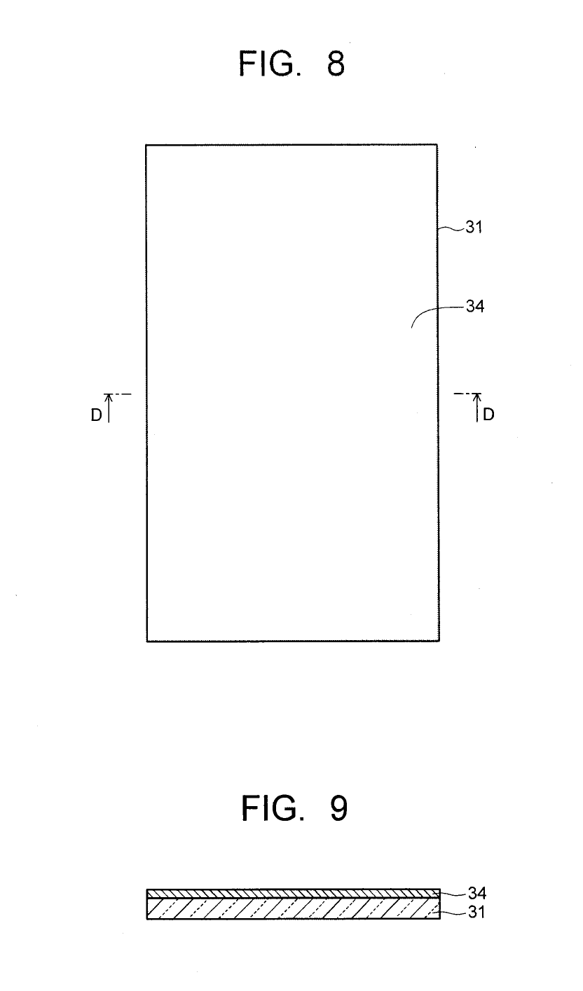

Next, as shown in FIG. 8 and FIG. 9, a SiNₓ film 34 (x=1.2) of 100 nm is formed by a sputtering method on a surface of a substrate 31 made of AN100 (manufactured by ASAHI GLASS CO. LTD., 25 mm×15 mm×0.5 mm in thickness) being a non-alkali glass.

Separately from the above, as shown in FIG. 10 and FIG. 11, the above-described sealing material paste is applied in a frame shape by using a 400 mesh screen to a surface of a substrate 32 made of AN100 (manufactured by ASAHI GLASS CO., LTD., 25 mm×15 mm×0.5 mm in thickness) being a non-alkali glass, dried under a condition of 120° C.×10 minutes, and burned under a condition of 500° C.×10 minutes, to bake and form a pre-baked layer 35a. The pre-baked layer 35a has a size of 9 mm×9 mm in a center of a line width, and R of a corner portion is 1 mm in a center of a line width. Note that the pre-baked layer 35a is made to have a width of about 500 μm and a film thickness of about 4 μm to 5 μm when made into a sealing layer 35.

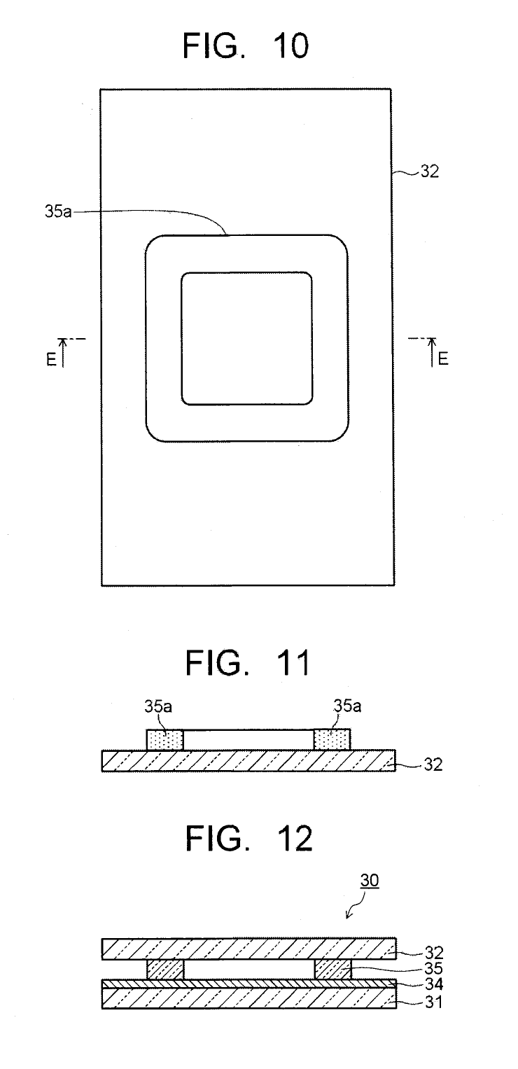

Thereafter, the substrate 31 in which the SiNₓ film 34 is provided and the substrate 32 in which the pre-baked layer 35a is provided are overlapped in a manner that the SiNₓ film 34 and the pre-baked layer 35a contact each other, to obtain an assembly. Further, to this assembly, a laser light (a semiconductor laser) having a wavelength of 940 nm and a spot diameter of 1.6 mm is irradiated from a substrate 32 side at a scan speed of 10 mm/s, so that the pre-baked layer 35a is melted, and rapidly cooled and solidified. Thereby, as shown in FIG. 12, fabricated is a test piece 30 for measurement of an adhesive strength, in the test piece 30 the substrate 32 being bonded via the sealing layer 35 to the substrate 31 provided with the SiNₓ film 34.

An output of the laser light is adjusted to be between 25 to 120 W, while a sealing degree is checked. Concretely, to examples A to I, a comparative example A, a comparative example C, and a comparative example D, a condition where a later-described foaming area becomes 0.1 to 5% or less is applied. To a comparative example B, a condition is applied where the output of the laser light is raised without regard to a size of the foaming area and where a width of the sealing layer 35 becomes the same as a width of the pre-baked layer 35a.

Next, as shown in FIG. 13 and FIG. 14, supporting substrates 41, 42 of 100 mm×50 mm×1.8 mm in thickness are fixed to both surfaces of the test piece 30 by a thermosetting adhesive 43. As the thermosetting adhesive 43, Araldite (trade name) manufactured by NICHIBAN CO., LTD. is used. Note that the supporting substrates 41, 42 are disposed in a manner that longitudinal directions thereof are orthogonal to each other.

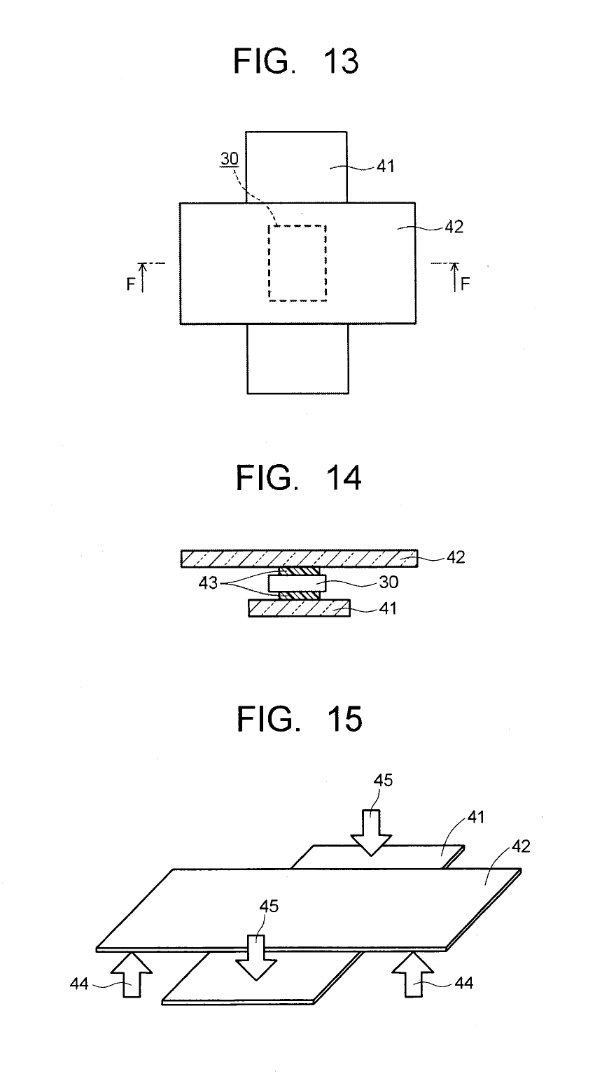

Thereafter, as shown in FIG. 15, while both end portions of the supporting substrate 42 of an upper side are supported from a lower side as indicated by arrows 44, a load is applied to both end portions of the supporting substrate 41 of a lower side from the upper side as indicated by arrows 45, and a load at a time that a pair of substrates 31, 32 of the test piece 30 are peeled is measured as an adhesive strength. Note that TCM1000CR manufactured by Minebea Co., Ltd. is used for measurement.

Further, in one having a configuration similar to that of the test piece 30, observation and photography of a sealed portion of each center part of four sides in the sealing layer 35 of the frame shape is performed from a substrate 31 side by using a metallurgical microscope (manufactured by Olympus Corporation, trade name: BX51), binarization is performed by two-dimensional image analysis software (manufactured by MITANI CORPORATION, trade name: WinROOF), and a ratio (area of foam/area of sealing layer×100[%]) of an area of foam to an area (a range of 450 μm×450 μm) of the sealing layer 35 is measured. Ratios of areas of foam in four places are averaged, and a foaming area is obtained.

TABLE 5

| | | Example | | | | | |
|---|---|---|---|---|---|---|---|
| | | A | | B | | C | |
| Sealing | Glass composition | Example 6 | 68.9 | Example 8 | 68.9 | Example 12 | 61.0 |
| material | Laser absorbent | Fe₂O₃—CuO—MnO | 10.8 | Fe₂O₃—CuO—MnO | 10.8 | Fe₂O₃—CuO—MnO | 5.0 |
| [vol %] | Low-expansion filler | Cordierite | 20.3 | Cordierite | 20.3 | Zirconium | 34.0 |
| | | | | | | phosphate | |
| Vehicle | Resin | Ethyl cellulose | 3.5 | Ethyl cellulose | 3.5 | Poly(isobutyl | 5 |
| [mass %] | | | | | | methacrylate) | |
| | Solvent | 2,2,4-trimethyl-1,3- | 96.5 | 2,2,4-trimethyl-1,3- | 96.5 | 2,2,4-trimethyl-1,3- | 95 |
| | | pentanediol | | pentanediol | | pentanediol | |
| | | monoisobutyrate | | monoisobutyrate | | monoisobutyrate | |

| | | | | |
|---|---|---|---|---|
| Sealing | Mass fraction of sealing | 79.5:21.5 | 77:23 | 675:25 |
| material | material to vehicle (sealing | | | |
| paste | material:vehicle) | | | |
| Manufacturing | Laser light output [W] | 67 | 68 | 115 |
| condition | | | | |
| Evaluation | Foaming area [%] | 1.5 | 2 | 1.4 |
| | Adhesive strength [kg] | 7.9 | 7.4 | 7.3 |

TABLE 6

| | | Example | | | | | |
|---|---|---|---|---|---|---|---|
| | | D | | E | | F | |
| Sealing material [vol %] | Glass composition | Example 12 | 74.3 | Example 31 | 74.3 | Example 12 | 63.5 |
| | Laser absorbent | Fe₂O₃—CuO—MnO | 10.7 | Fe₂O₃—CuO—MnO | 10.7 | Fe₂O₃—CuO—MnO | 10.0 |
| | Low-expansion filler | Cordierite | 15.0 | Cordierite | 15.0 | Zirconium | 26.5 |
| | | | | | | phosphate | |
| Vehicle [mass %] | Resin | Polypropylene | 5 | Polypropylene | 5 | Polypropylene | 10 |
| | | carbonate | | carbonate | | carbonate | |
| | Solvent | Triethyl acetyl | 95 | Triacetin | 95 | Triethyl acetyl | 90 |
| | | citrate | | | | citrate | |

| | | | | |
|---|---|---|---|---|
| Sealing material paste | Mass fraction of sealing | 70:30 | 70:30 | 70:30 |
| | material to vehicle (sealing | | | |
| | material:vehicle) | | | |
| Manufacturing condition | Laser light output [W] | 65 | 50 | 68 |
| Evaluation | Foaming area [%] | 1.4 | 0.8 | 1.1 |
| | Adhesive strength [kg] | 6.9 | 7.3 | 7.2 |

TABLE 7

| | | Example | | | | | |
|---|---|---|---|---|---|---|---|
| | | G | | H | | I | |
| Sealing material [vol %] | Glass composition | Example 12 | 61.0 | Example 12 | 64.0 | Example 33 | 64.0 |
| | Laser absorbent | Fe₂O₃—CuO—MnO | 5.0 | Fe₂O₃—CuO—MnO | 5.0 | Fe₂O₃—CuO—MnO | 5.0 |
| | Low-expansion filler | Zirconium | 34.0 | Zirconium | 31.0 | Zirconium | 31.0 |
| | | phosphate | | phosphate | | phosphate | |
| Vehicle [mass %] | Resin | Polypropylene | 10 | Polypropylene | 9 | Polypropylene | 9 |
| | | carbonate | | carbonate | | carbonate | |
| | Solvent | Triethyl acetyl | 90 | Triethyl acetyl | 91 | Triethyl acetyl | 91 |
| | | citrate | | citrate | | citrate | |

| | | | | |
|---|---|---|---|---|
| Sealing material paste | Mass fraction of sealing | 70:30 | 70:30 | 70:30 |
| | material to vehicle (sealing | | | |
| | material:vehicle) | | | |
| Manufacturing condition | Laser light output [W] | 115 | 114 | 112 |
| Evaluation | Foaming area [%] | 1.1 | 1.1 | 0.9 |
| | Adhesive strength [kg] | 7.4 | 7.5 | 7.4 |

TABLE 8

| | | Comparative Example | | | | | | | |
|---|---|---|---|---|---|---|---|---|---|
| | | A | | B | | C | | D | |
| Sealing | Glass | Comparative | 74.3 | Comparative | 74.3 | Comparative | 74.3 | Comparative | 76.0 |
| material | composition | Example 3 | | Example 3 | | Example 4 | | Example 5 | |
| [vol %] | Laser absorbent | Fe₂O₃—CuO—MnO | 10.7 | Fe₂O₃—CuO—MnO | 10.7 | Fe₂O₃—CuO—MnO | 10.7 | — | — |
| | Low-expansion | Cordierite | 15.0 | Cordierite | 15.0 | Cordierite | 15.0 | Zirconium | 24.0 |
| | filler | | | | | | | phosphate | |
| Vehicle | Resin | Ethyl cellulose | 4 | Ethyl cellulose | 4 | Ethyl cellulose | 4 | Polypropylene | 10 |
| [mass %] | | | | | | | | carbonate | |
| | Solvent | 2,2,4-trimethyl- | 96 | 2,2,4-trimethyl- | 96 | 2,2,4-trimethyl- | 96 | 2,2,4-trimethyl-1, | 90 |
| | | 1,3-pentanediol | | 1,3-pentanediol | | 1,3-pentanediol | | 3-pentanediol | |
| | | monoisobutyrate | | monoisobutyrate | | monoisobutyrate | | monoisobutyrate | |

| | | | | | |
|---|---|---|---|---|---|
| Sealing | Mass fraction of | 80:20 | 80:20 | 80:20 | 85:15 |
| material | sealing material | | | | |
| paste | to vehicle | | | | |
| | (sealing | | | | |
| | material:vehicle) | | | | |
| Manu- | Laser light output | 27 | 31 | 27.3 | 90 |
| facturing | [W] | | | | |
| condition | | | | | |
| Evaluation | Foaming area [%] | 2 | 28 | 2.3 | 0.8 |
| | Adhesive strength | 3.5 | 5.9 | 2.6 | 4 |
| | [kg] | | | | |

The glass compositions of the examples, in which devitrification and phase splitting are suppressed, are each good in vitrification, and have a large adhesive strength since the foaming area when sealed is suppressed. On the other hand, when a large quantity of an alkali component is included as in a glass composition of a comparative example 1, phase splitting is apt to occur. When a large quantity of Al₂O₃ is included as in a glass composition of a comparative example 2, an undissolved matter being a material not dissolved is apt to occur at a melting time. Further, in a case where TeO₂ is not contained but Bi₂O₃ is contained as much as 45.1 mol % as in a glass composition of the comparative examples 3, 4, if an output of the laser light is lowered to suppress the foaming area, the glass composition cannot be sufficiently dissolved and the adhesive strength is small, and if the output of the laser light is raised, the foaming area becomes large and consequently an adhesive strength is not made large.

Further, in a case where TeO₂ is contained but a large amount of V₂O₅ is included and Bi₂O₃ is not included as in a glass composition of a comparative example 5, a foaming area is hard to become large even if an output of a laser light is raised. However, since a reaction of a nitride film and the glass composition is low, a strength of a glass material is also weak, and consequently, tan adhesive strength is not made large.

### Example J

Similarly to in the example C, an assembly is fabricated in which a substrate 31 provided with a SiNₓ film 34 and a substrate 32 provided with a pre-baked layer 35a are overlapped in a manner that the SiNₓ film 34 and the pre-baked layer 35a contact each other. An entire of this assembly is disposed in an electric furnace, the entire of the assembly including the pre-baked layer 35a is heated, to fabricate a test piece 30 in which the substrate 32 is bonded to the substrate 31 provided with the SiNₓ film 34 via a sealing layer 35. The test piece 30 is observed with an optical microscope, and it is recognized that the substrate 31 provided with the SiNₓ film 34 and the substrate 32 are bonded well by the sealing layer 35.

What is claimed is:

1. A glass composition comprising, in mole percentage based on following oxides, 30% to 90% of TeO₂, 0% to 60% of ZnO, 0% to 24% of B₂O₃, 0% to 8% of Li₂O+Na₂O+K₂O, 0% to 8% of Al₂O₃, 0% to 17% of Bi₂O₃, 0% to 30% of V₂O₅, and 0% to 10% of SiO₂; and not substantially containing any of components having F, Pb, Cd, W, Mo, Ag, or Gd.

2. The glass composition according to claim 1, comprising, in mole percentage based on following oxides, 30% to 90% of TeO₂, 0% to 60% of ZnO, 0% to 24% of B₂O₃, 0% to 8% of Li₂O+Na₂O+K₂O, 0% to 8% of Al₂O₃, 0% to 17% of Bi₂O₃, and 0% to 10% of SiO₂; and not substantially containing V₂O₅.

3. The glass composition according to claim 1, comprising, in mole percentage based on following oxides, 45% to 70% of TeO₂, 10% to 35% of ZnO, 3% to 22% of B₂O₃, 0% to 3% of Li₂O+Na₂O+K₂O, 0% to 6% of Al₂O₃, 2% to 6% of Bi₂O₃, and 0% to 3% of SiO₂; and not substantially containing V₂O₅.

4. The glass composition according to claim 1, comprising, in mole percentage based on following oxides, 45% to 70% of TeO₂, 10% to 35% of ZnO, 3% to 22% of B₂O₃, 0% to 3% of Li₂O+Na₂O+K₂O, 0.5% to 6% of Al₂O₃, 2% to 6% of Bi₂O₃, and 0% to 3% of SiO₂; and not substantially containing V₂O₅.

5. The glass composition according to claim 1, comprising, in mole percentage based on following oxides, 45% to 80% of TeO₂, 1% to 17% of Bi₂O₃, and 5% to 30% of V₂O₅.

6. The glass composition according to claim 1, comprising, in mole percentage based on following oxides, 45% to 65% of TeO₂, 10% to 15% of Bi₂O₃, and 25% to 30% of V₂O₅.

7. A sealing material comprising the glass composition according to claim 1.

8. The sealing material according to claim 7 used for sealing of a substrate having a nitride film.

9. The sealing material according to claim 7, further comprising a low-expansion filler.

10. The sealing material according to claim 7 used for sealing performed by irradiation of a laser light.

11. The sealing material according to claim 10, further comprising a laser absorbent.

12. A sealed package comprising:
a first substrate;
a second substrate disposed to face the first substrate; and
a sealing layer disposed between the first substrate and the second substrate, bonding the first substrate and the second substrate, and formed by the sealing material according to claim 7 being melted and solidified.

13. The sealed package according to claim 12, further comprising:
a nitride film between at least one of substrate selected from the first substrate and the second substrate, and the sealing layer.
